(19) United States
(12) Patent Application Publication
(10) Pub. No.: US 2024/0237128 A9
(43) Pub. Date: Jul. 11, 2024

(54) USER EQUIPMENT ASSISTANCE INFORMATION NEGOTIATION METHOD, RELATED USER EQUIPMENT AND NETWORK TERMINAL

(71) Applicant: MediaTek Singapore Pte. Ltd., Singapore (SG)

(72) Inventors: Hung-Yueh Chen, SeongNam-si (KR); Yu-Lun Chang, Hsinchu City (TW); Byeng Hyun Kim, Seongnam-si (KR); JUNG SHUP SHIN, Seongnam-si (KR); Hung-Yuan Yang, Hsinchu City (TW); Jun-Jie Su, Hsinchu City (TW); Kyung Hyun Ahn, SeongNam-si (KR)

(73) Assignee: MediaTek Singapore Pte. Ltd., Singapore (SG)

(21) Appl. No.: 18/376,431

(22) Filed: Oct. 3, 2023

Related U.S. Application Data
(60) Provisional application No. 63/380,078, filed on Oct. 19, 2022.

(51) Int. Cl. H04W 76/27; H04W 76/38

(52) U.S. Cl. CPC H04W 76/27; H04W 76/38

(57) ABSTRACT

A user equipment assistance information (UAI) negotiation method, for a user equipment (UE) of mobile communication includes receiving a first OtherConfig element of an RRC reconfiguration message comprising a plurality of configuration parameters with SETUP values from a network terminal; sending a first UAI including a first value of a first configuration parameter of the configuration parameters to the network terminal; and receiving a first RRC reconfiguration message corresponding to the first UAI from the network terminal.

### CROSS REFERENCE TO RELATED APPLICATIONS

This application claims the benefit of U.S. Provisional Application No. 63/380,078, filed on Oct. 19, 2022. The content of the application is incorporated herein by reference.

### BACKGROUND

In mobile communications, such as 5th Generation (5G) New Radio (NR) based on the 3rd Generation Partnership Project (3GPP) specifications, it is the role of the base station to configure user equipment (UE) by control-signaling based on the channel status between the base station and the UE.

In an example, the base station may determine the configuration through artificial intelligence big data in the communication system. However, the base station does not know whether the configuration can meet requirements when the UE executes an application. UE can suggest the network to decrease the resource, e.g. component carrier (CC) and multi-input multi-output (MIMO), for power saving and thermal/overheating control, and to increase the resource for the demand of higher throughput with the feature of UE assistance information (UAI).

However, the network may decline suggestions from the UE. For example, the configuration suggested by the UE is not supported, the suggested resource is not available, network busy or network failure, etc.

Therefore, how to determine configuration based on what the UE expects is important to the industry.

### SUMMARY

In light of this, the present invention provides a user equipment assistance information negotiation method, related user equipment and network terminal which handles the scenario between the UE and the network with UAI.

An embodiment of the present invention discloses a user equipment assistance information (UAI) negotiation method, for a user equipment (UE) of mobile communication, comprises receiving a first OtherConfig element of an RRC reconfiguration message comprising a plurality of configuration parameters with SETUP values from a network terminal; sending a first UAI including a first value of a first configuration parameter of the configuration parameters to the network terminal; and receiving a first RRC reconfiguration message corresponding to the first UAI from the network terminal.

Another embodiment of the present invention discloses a user equipment (UE) for mobile communication, comprises a wireless transceiver, configured to perform wireless transmission and reception to and from a network terminal of a mobile communication network; and a controller, configured to receive a first OtherConfig element of an RRC reconfiguration message comprising a plurality of configuration parameters with SETUP values from a network terminal; send a first UAI including a first value of a first configuration parameter of the configuration parameters to the network terminal; and receive a first RRC reconfiguration message corresponding to the first UAI from the network terminal.

Another embodiment of the present invention discloses a network terminal station for mobile communication, comprises a core network; and an access network, configured to transmit a first OtherConfig element of an RRC reconfiguration message comprising a plurality of configuration parameters with SETUP values to a user equipment (UE); receive a first user equipment assistance information (UAI) including a first value of a first configuration parameter of the configuration parameters from the UE; and send a first RRC reconfiguration message corresponding to the first UAI to the UE.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication network according to an embodiment of the present invention.

FIG. 2 is a schematic diagram of a UE assistance information (UAI) according to an embodiment of the present invention.

FIG. 3 is a schematic diagram of a UAI negotiation scenario applied to the UE according to an embodiment of the present invention.

FIG. 4 is a schematic diagram of a UAI negotiation scenario applied to the UE according to an embodiment of the present invention.

FIG. 5 is a schematic diagram of a UAI negotiation scenario applied to the UE according to an embodiment of the present invention.

FIG. 6 is a schematic diagram of a UAI negotiation scenario applied to the UE according to an embodiment of the present invention.

FIG. 7 is a schematic diagram of a UAI negotiation flowchart applied to the network terminal according to an embodiment of the present invention.

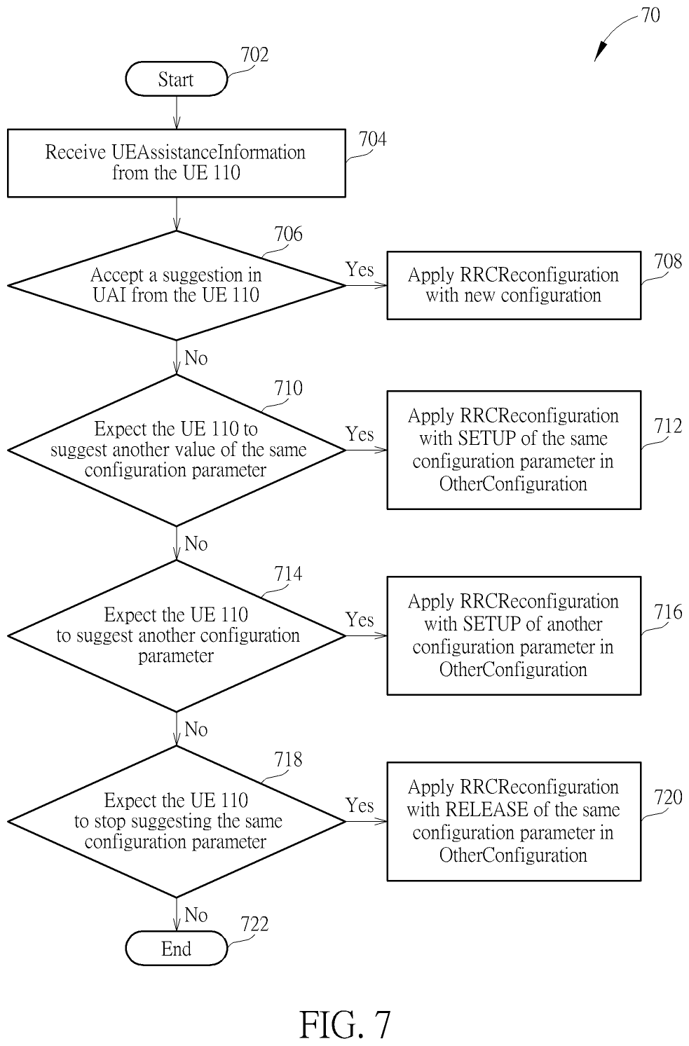

FIG. 8 is a schematic diagram of a UAI negotiation flowchart applied to the UE according to an embodiment of the present invention.

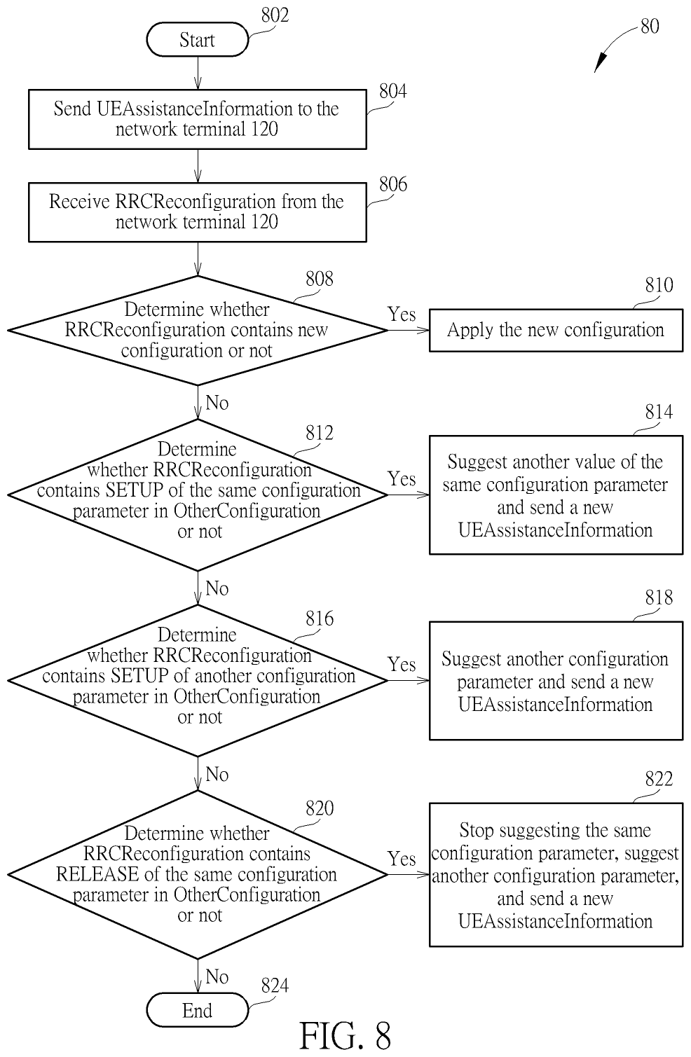

### DETAILED DESCRIPTION

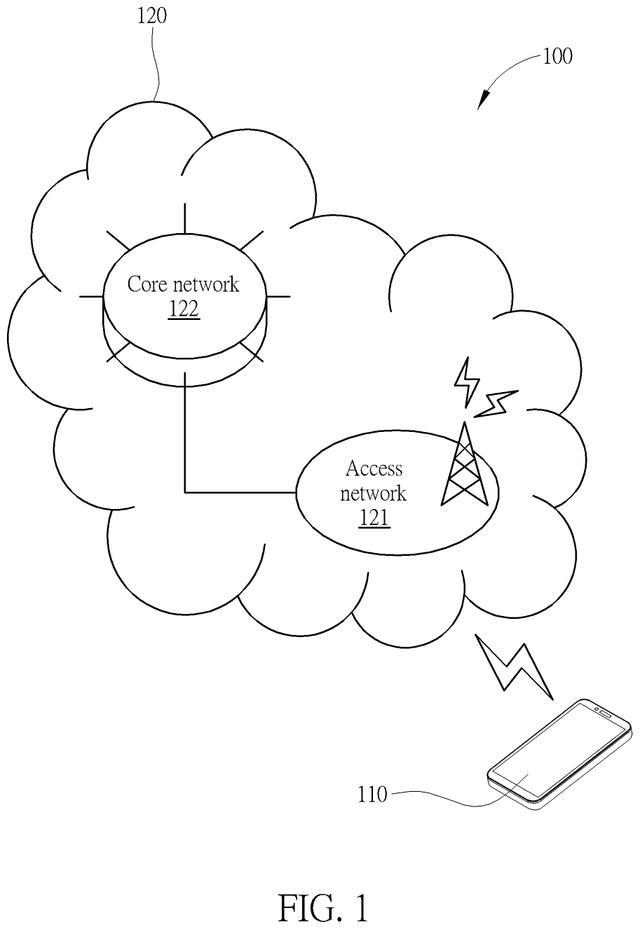

Please refer to FIG. 1, which is a schematic diagram of a wireless communication network 10 according to an embodiment of the present invention.

As shown in FIG. 1, the wireless communication network 100 may include a user equipment (UE) 110 and a network terminal 120, wherein the UE 110 may be wirelessly connected to the network terminal 120 for obtaining mobile services and performing cell measurements on the cell(s) of the network terminal 120.

The UE 110 may be a feature phone, a smartphone, a panel Personal Computer (PC), a laptop computer, or any wireless communication device supporting the wireless technology (e.g. the 5G NR technology) utilized by the network terminal 120. In another embodiment, the UE 110 may support more than one wireless technology. For example, the UE 110 may support the 5G NR technology and a legacy 4G technology, such as the LTE/LTE-A/TD-LTE technology.

The network terminal 120 includes an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g. the Internet). Each of the access network 121 and the core network 122 may comprise one or more network nodes for carrying out said functions.

It should be understood that the wireless communication network 100 described in the embodiment of FIG. 1 is for illustrative purposes only and is not intended to limit the scope of the application. For example, the wireless communication network 100 may include both a 5G NR network and a legacy network (e.g. an LTE/LTE-A/TD-LTE network, or a WCDMA network), and the UE 110 may be wirelessly connected to both the 5G NR network and the legacy network.

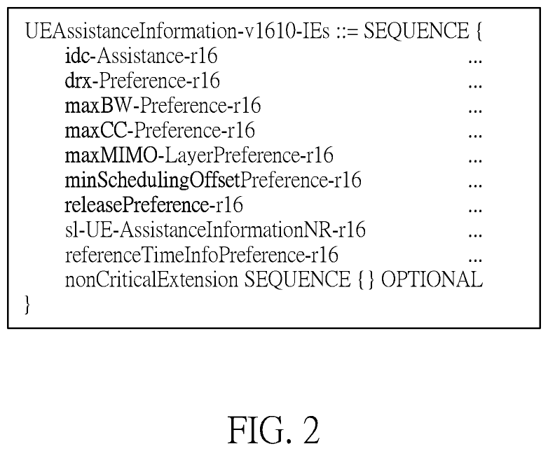

Please refer to FIG. 2, which is a schematic diagram of a UE assistance information (UAI) according to an embodiment of the present invention.

As shown in FIG. 2, the UAI may include configuration parameters, e.g. in-device coexistence idc, drx, maxBW, maxCC, maxMIMO, minSchedulingOffset, releasePreference, etc., wherein the configuration parameter idc is in-device coexistence, the configuration parameter maxBW is a maximal bandwidth, the configuration parameter maxCC is a maximal number of component carrier, the configuration parameter maxMIMO is a number of antenna of multi-input multi-output, the configuration parameter minSchedulingOffset is a minimal value of scheduling offset, and the configuration parameter releasePreference is related to whether to release the connection or not.

The UAI shown in FIG. 2 may be utilized by the UE 110 to suggest the network terminal 120 to decrease the resource for power saving and thermal/overheating control, e.g. the number of component carrier and the number of antenna of the MIMO. In another embodiment, the UAI may be utilized by the UE 110 to suggest the network terminal 120 to increase the resource for demand of higher throughput.

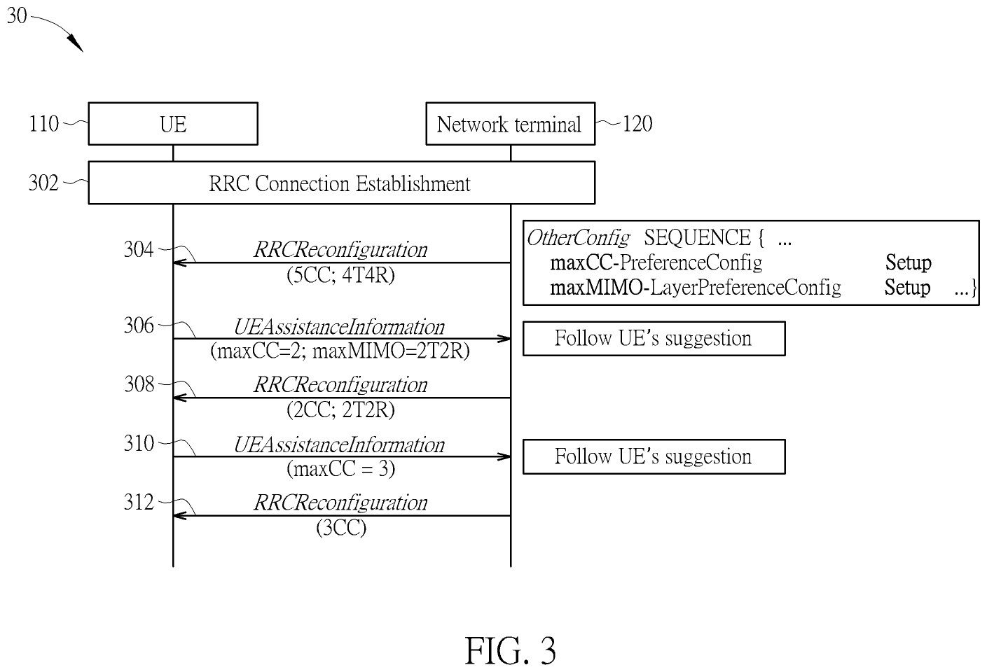

Please refer to FIG. 3, which is a schematic diagram of a UAI negotiation scenario 30 applied to the UE 110 according to an embodiment of the present invention. The UAI negotiation scenario 30 includes the following steps:
Step 302: The RRC connection between the UE 110 and the network terminal 120 is established;
Step 304: The network terminal 120 sends an OtherConfig element of an RRC reconfiguration message comprising a plurality of configuration parameters with SETUP values;
Step 306: The UE 110 sends a first UAI including a first value of a first configuration parameter of the configuration parameters to the network terminal 120;
Step 308: The UE 110 receives a first RRC reconfiguration message corresponding to the first UAI from the network terminal 120;
Step 310: The UE 110 sends a second UAI including a second value of a second configuration parameter of the configuration parameters to the network terminal 120;
Step 312: The UE 110 receives a second RRC reconfiguration message corresponding to the second UAI from the network terminal 120.

According to the UAI negotiation scenario 30, after the RRC connection is established in step 302, the OtherConfig element of the RRC reconfiguration message is sent from the network terminal 120 to the UE 110 in step 304. In an embodiment, a sequence of the OtherConfig element includes configuration parameters, i.e. maxCC and max MIMO, with corresponding setup values, e.g. 5 component carriers (5CC) and 4-transmitter-4-receiver (4T4R).

In step 306, the UE 110 sends the first UAI including the first value corresponding to the configuration parameters to the network terminal 120. In an embodiment, the UE 110 may suggest the required configuration parameters to the network terminal 120 according to the application in operation. In step 306, when the UE 110 is in a power saving mode, the suggested configuration parameters may be 2CC and 2T2R, and the UE 110 receives the first RRC reconfiguration message corresponding to the first UAI from the network terminal 120 in step 308 if the network terminal 120 accepts and follows the suggestion of the UE 110.

In another embodiment, when the application, e.g. playing streaming videos, on the UE 110 needs more resources, the UE 110 may suggest the configuration parameters to the network terminal 120 accordingly. That is, the UE 110 sends the second UAI including the second value, e.g. maxCC=3, of the second configuration parameter of the configuration parameters to the network terminal 120.

In step 312, the UE 110 receives the second RRC reconfiguration message corresponding to the second UAI from the network terminal 120 if the network terminal 120 follows the suggestion of the UE 110.

Notably, in step 308 and step 312, the UE 110 is configured to determine whether the first and the second RRC reconfiguration messages from the network terminal 120 comprise the first value of the first configuration parameter or not; if yes (i.e. the first value of the first configuration parameter is included in the first and the second RRC reconfiguration messages), the UE 110 applies the first value of the first configuration parameter; if no (i.e. the first value of the first configuration parameter is not included in the first and the second RRC reconfiguration messages), please refer to the following examples.

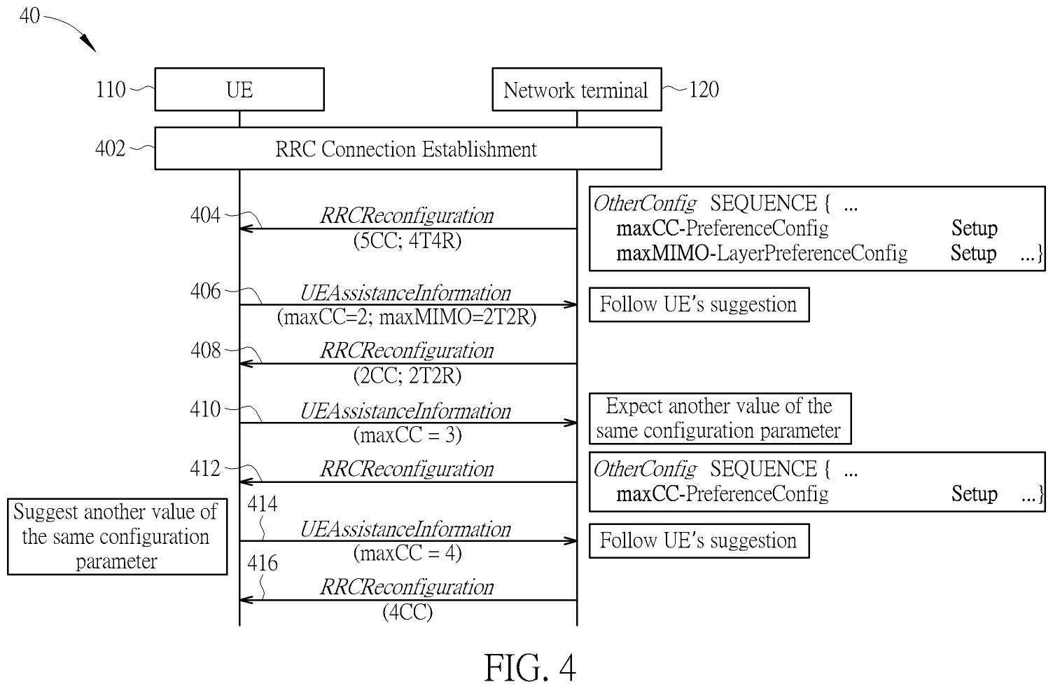

Please refer to FIG. 4, which is a schematic diagram of a UAI negotiation scenario 40 applied to the UE 110 according to an embodiment of the present invention. The UAI negotiation scenario 40 includes the following steps:
Step 402: The RRC connection between the UE 110 and the network terminal 120 is established;
Step 404: The network terminal 120 sends an OtherConfig element of an RRC reconfiguration message comprising a plurality of configuration parameters with SETUP values;
Step 406: The UE 110 sends a first UAI including a first value of a first configuration parameter of the configuration parameters to the network terminal 120;
Step 408: The UE 110 receives a first RRC reconfiguration message corresponding to the first UAI from the network terminal 120;
Step 410: The UE 110 sends a second UAI including a second value of the first configuration parameter to the network terminal 120 when the first value of the first configuration parameter is not included in the first UAI, wherein the first value and the second value of the first configuration parameters are different;
Step 412: The UE 110 receives a second OtherConfig element of a second RRC reconfiguration message comprising the second value of the first configuration parameter corresponding to the second UAI from the network terminal 120;
Step 414: The UE 110 sends a third UAI including a value of the first configuration parameter corresponding to the second UAI to the network terminal 120;
Step 416: The UE 110 receives a third RRC reconfiguration message corresponding to the third UAI from the network terminal 120.

According to the UAI negotiation scenario 40, after the RRC connection is established in step 402, the OtherConfig element of the RRC reconfiguration message is sent from the network terminal 120 to the UE 110 in step 404. In steps 406-408, the network terminal 120 accepts and follows the suggestion of the UE 110. In step 410 of the UAI negotiation scenario 40, the UE 110 sends a second UAI including a second value of the first configuration parameter to the network terminal 120 when the first value of the first configuration parameter is not included in the first UAI.

In this example, when the application, e.g. playing streaming videos, on the UE 110 needs more resources, the UE 110 may suggest the second value, e.g. maxCC=3, of the first configuration parameter to the network terminal 120 accordingly, wherein the first value (e.g. maxCC=2) and the second value (e.g. maxCC=3) of the first configuration parameters are different.

In step 412, when the network terminal 120 expects another value of the first configuration parameter, the UE 110 receives the second OtherConfig element of the second RRC reconfiguration message comprising the second value of the first configuration parameter corresponding to the second UAI from the network terminal 120.

In step 414, the UE 110 sends the third UAI including the third value, e.g. maxCC=4, of the first configuration parameter corresponding to the second UAI to the network terminal 120. In step 416, the UE 110 receives the third RRC reconfiguration message corresponding to the second UAI from the network terminal 120 after the network terminal 120 accepts and follows the suggestion of the UE 110.

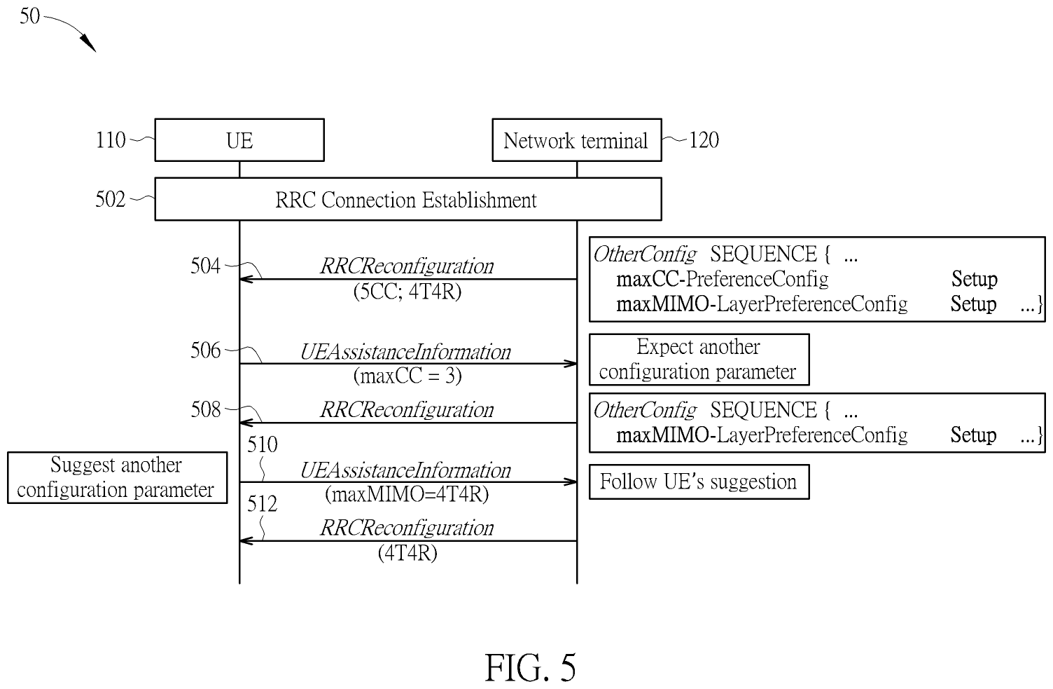

Please refer to FIG. 5, which is a schematic diagram of a UAI negotiation scenario 50 applied to the UE 110 according to an embodiment of the present invention. The UAI negotiation scenario 50 includes the following steps:
Step 502: The RRC connection between the UE 110 and the network terminal 120 is established;
Step 504: The network terminal 120 sends an OtherConfig element of an RRC reconfiguration message comprising a plurality of configuration parameters with SETUP values;
Step 506: The UE 110 sends a first UAI including a first value of a first configuration parameter of the configuration parameters to the network terminal 120;
Step 508: The UE 110 receives a second OtherConfig element of a second RRC reconfiguration message comprising a second value of a second configuration parameter corresponding to the first UAI from the network terminal 120;
Step 510: The UE 110 sends a second UAI including a second value of a second configuration parameter of the configuration parameters to the network terminal 120 when the second configuration parameter is not included in the first UAI, wherein the second configuration parameter and the first configuration parameter are different;
Step 512: The UE 110 receives a second RRC reconfiguration message corresponding to the second UAI from the network terminal 120.

In step 502, the RRC connection is established. In step 504, the network terminal 120 sends an OtherConfig element of an RRC reconfiguration message comprising a plurality of configuration parameters with SETUP values, e.g. 5CC, 4T4R.

In step 506, when the application, e.g. playing streaming videos, on the UE 110 needs more resources, the UE 110 may send a first UAI including a first value (e.g. maxCC=3) of a first configuration parameter of the configuration parameters to the network terminal 120 accordingly.

In step 508, the UE 110 receives the second OtherConfig element of the second RRC reconfiguration message comprising the second value of the second configuration parameter corresponding to the first UAI from the network terminal 120. That is, the network sends the second OtherConfig element in the first UAI containing other parameters without including the suggested parameter of the UE 110.

In step 510, the UE 110 suggests another configuration parameter and sends the second UAI including the second value of the second configuration parameter of the configuration parameters, i.e. maxMIMO=4T4R, to the network terminal 120, wherein the second configuration parameter (i.e. maxMIMO) and the first configuration parameter (i.e. maxCC) are different.

In step 512, the UE 110 receives the second RRC reconfiguration message corresponding to the second UAI from the network terminal 120 after the network terminal 120 accepts and follows the suggestion of the UE 110.

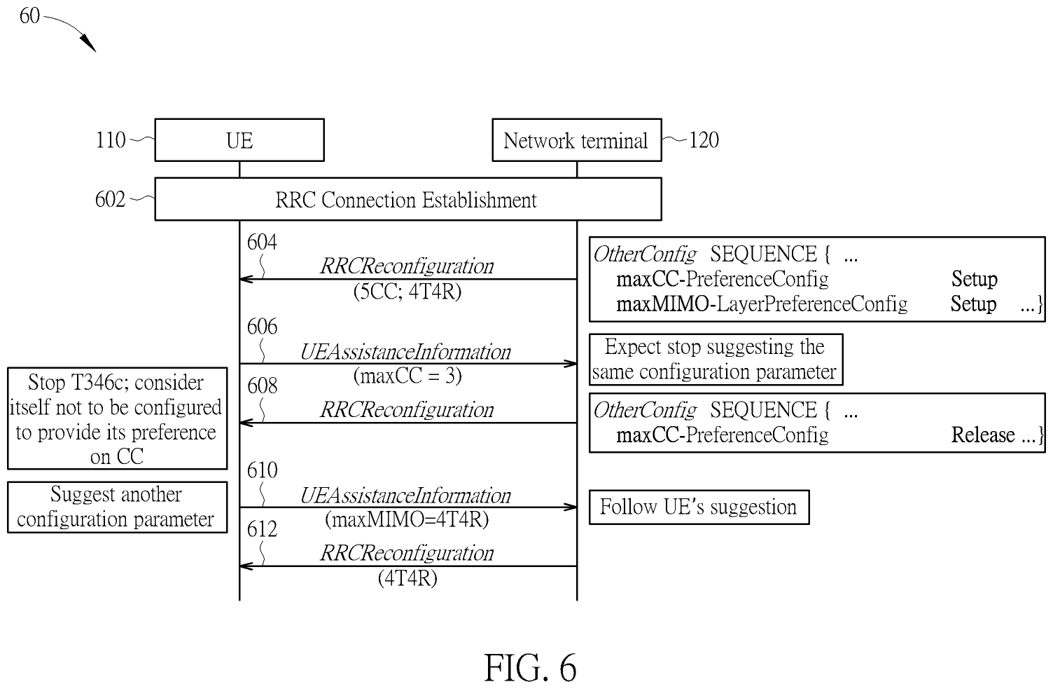

Please refer to FIG. 6, which is a schematic diagram of a UAI negotiation scenario 60 applied to the UE 110 according to an embodiment of the present invention. The UAI negotiation scenario 60 includes the following steps:
Step 602: The RRC connection between the UE 110 and the network terminal 120 is established;
Step 604: The network terminal 120 sends an OtherConfig element of an RRC reconfiguration message comprising a plurality of configuration parameters with SETUP values;
Step 606: The UE 110 sends a first UAI including a first value of a first configuration parameter of the configuration parameters to the network terminal 120;
Step 608: The UE 110 receives a second OtherConfig element of a second RRC reconfiguration message comprising a second value of a second configuration parameter corresponding to the first UAI from the network terminal 120, stops a timer when the second configuration parameter of the second RRC reconfiguration message is with a release value;
Step 610: The UE 110 sends a second UAI including a second value of a second configuration parameter of the configuration parameters to the network terminal 120 when the second configuration parameter is not included in the first UAI, wherein the second configuration parameter and the first configuration parameter are different;
Step 612: The UE 110 receives a second RRC reconfiguration message corresponding to the second UAI from the network terminal 120.

In step 602, the RRC connection is established. In step 604, the network terminal 120 sends an OtherConfig element of an RRC reconfiguration message comprising a plurality of configuration parameters with SETUP values, e.g. 5CC, 4T4R.

In step 606, when the application the UE 110 needs more resources, the UE 110 may send a first UAI including a first value (e.g. maxCC=3) of a first configuration parameter of the configuration parameters to the network terminal 120 accordingly.

When the network terminal 120 expects that the UE 110 may stop suggesting the same configuration parameter, the network terminal 120 sends the second OtherConfig element of the second RRC reconfiguration message comprising the second value of the second configuration parameter corresponding to the first UAI to the UE 110 in step 608.

That is, the UE 110 receives the second OtherConfig element of the second RRC reconfiguration message comprising the second value of the second configuration parameter corresponding to the first UAI from the network terminal 120 in step 608.

In addition, in step 608, the UE 110 determines whether the first configuration parameter of the RRC reconfiguration message is with the release value, and stops the timer when the second configuration parameter of the second RRC reconfiguration message is with the release value, i.e. the UE 110 considers itself not to be configured to provide its preference on component carrier.

In an embodiment, the timer is a T346c timer for maxCC-preference, and the T346c timer may be temporarily reduced for the UE 110 to report another value or configuration parameter earlier.

In step 610, the UE 110 sends the second UAI including the second value of the second configuration parameter of the configuration parameters, e.g. maxMIMO=4T4R, to the network terminal 120, wherein the second configuration parameter (i.e. maxMIMO) and the first configuration parameter (i.e. maxCC) are different.

In step 612, the UE 110 receives the second RRC reconfiguration message corresponding to the second UAI from the network terminal 120 after the network terminal 120 accepts and follows the suggestion of the UE 110.

In order to prevent Ping-Pong, i.e. too many roundtrips or long waiting time, between the UE 110 and the network terminal 120, the following measurements may be adopted.

A protection timer or a max counter may be applied on the network terminal 120 to stop the negotiation with the UE 110. Once the protection timer expires or the max counter reaches the maximal value, the network terminal 120 stops the UAI negotiation. Then, the network terminal 120 may trigger the UE 110 to change to another cell, e.g. by applying measurement reports, e.g. event A3 (Neighbor becomes offset better than SpCell), event A5 (SpCell becomes worse than a threshold 1 and neighbor becomes better than threshold 2.), for handover.

Alternatively, the network terminal 120 may send an RRCConnectionRelease message with either (1) idle mode reselection priority assignment when the network terminal 120 stops the UAI negotiation or (2) redirection information to another cell of same radio access technology (RAT) or another RAT when the network terminal 120 stops the UAI negotiation to the UE 110.

In another embodiment, the network terminal 120 may trigger the UE 110 to go to an inactive mode for power saving by sending an RRCConnectRelease with suspend or resume to a basic configuration, e.g. the configuration before changed due to the UAI messages when the network terminal 120 stops the UAI negotiation.

When the UE 110 has no more value or parameter to suggest for the UAI or when the UE 110 would like to stop waiting for the network's response, the UE 110 may trigger an RRC connection re-establishment procedure to reset the UAI, locally reduce a power consumption of the UE 110, e.g. numbers of CC, MIMO or RX, send a secondary cell group (SCG) failure information, apply an uplink (UL) throttle, i.e. suspend the UL traffic for a certain period, reduce the TX maximal power, remove the capability of FR2/FR1, switch RF heads, locally release the connection, and/or enter a flight mode for heating/thermal control.

The UAI negotiation scenarios 30-60 may be concluded to a UAI negotiation flowchart 70, applied to the network terminal 120. The UAI negotiation flowchart 70 includes the following steps:
Step 702: Start;
Step 704: Receive UEAssistanceInformation from the UE 110;
Step 706: Accept a suggestion in UAI from the UE 110;
Step 708: Apply RRCReconfiguration with new configuration;
Step 710: Expect the UE 110 to suggest another value of the same configuration parameter;
Step 712: Apply RRCReconfiguration with SETUP of the same configuration parameter in OtherConfiguration;
Step 714: Expect the UE 110 to suggest another configuration parameter;
Step 716: Apply RRCReconfiguration with SETUP of another configuration parameter in OtherConfiguration;
Step 718: Expect the UE 110 to stop suggesting the same configuration parameter;
Step 720: Apply RRCReconfiguration with RELEASE of the same configuration parameter in OtherConfiguration;
Step 722: End.

Refer to the embodiments of the UAI negotiation scenarios 30-60 mentioned above for the operation process of the UAI negotiation flowchart 70, which is not narrated herein for brevity.

Notably, the steps of expecting the UE 110 to suggest another value of the same configuration parameter (i.e. step 710) and expecting the UE 110 to suggest another configuration parameter (i.e. step 714) may be swapped, and not limited to the embodiment in the UAI negotiation flowchart 70.

The UAI negotiation scenarios 30-60 may be concluded to a UAI negotiation flowchart 80, applied to the UE 110. The UAI negotiation flowchart 80 includes the following steps:
Step 802: Start;
Step 804: Send UEAssistanceInformation to the network terminal 120;
Step 806: Receive RRCReconfiguration from the network terminal 120;
Step 808: Determine whether RRCReconfiguration contains new configuration or not, if yes, goes to step 810, if no, goes to step 812;
Step 810: Apply the new configuration;
Step 812: Determine whether RRCReconfiguration contains SETUP of the same configuration parameter in OtherConfiguration or not, if yes, goes to step 814, if no, goes to step 816;
Step 814: Suggest another value of the same configuration parameter and send a new UEAssistanceInformation;
Step 816: Determine whether RRCReconfiguration contains SETUP of another configuration parameter in OtherConfiguration or not, if yes, goes to step 818, if no, goes to step 820;
Step 818: Suggest another configuration parameter and send a new UEAssistanceInformation;
Step 820: Determine whether RRCReconfiguration contains RELEASE of the same configuration parameter in OtherConfiguration or not, if yes, goes to step 822, if no, goes to step 824;
Step 822: Stop suggesting the same configuration parameter, suggest another configuration parameter, and send a new UEAssistanceInformation; Step 824: End.

Refer to the embodiments of UAI negotiation scenarios 30-60 mentioned above for the operation process of the UAI negotiation flowchart 80, which is not narrated herein for brevity.

Notably, the steps of determine whether RRCReconfiguration contains SETUP of the same configuration parameter in OtherConfiguration or not (i.e. step 812) and determine whether RRCReconfiguration contains SETUP of another configuration parameter in OtherConfiguration or not (i.e. step 816) may be swapped, and not limited to the embodiment in the UAI negotiation flowchart 80.

It should be noted that, although the above embodiments are provided to illustrate the concept of the present invention, those skilled in the art may make modifications to the present invention based on different requirements, which are not limited thereto.

In summary, the present invention provides a user equipment assistance information negotiation method and related user equipment which handles the scenario between a legacy UE and the network with current over-the-air (OTA) definition.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A user equipment assistance information (UAI) negotiation method, for a user equipment (UE) of mobile communication, comprising:
receiving a first OtherConfig element of an RRC reconfiguration message comprising a plurality of configuration parameters with SETUP values from a network terminal;
sending a first UAI including a first value of a first configuration parameter of the configuration parameters to the network terminal; and
receiving a first RRC reconfiguration message corresponding to the first UAI from the network terminal.

2. The UAI negotiation method of claim 1, further comprising:
determining whether the RRC reconfiguration message from the network terminal comprises the first value of the first configuration parameter; and
applying the first value of the first configuration parameter when the first RRC reconfiguration message comprises the configuration parameter before a timer expires.

3. The UAI negotiation method of claim 1, further comprising:
determining whether the first configuration parameter of the RRC reconfiguration message is with a release value; and
stopping the timer.

4. The UAI negotiation method of claim 1, further comprising:
sending a second UAI including a second value of the first configuration parameter to the network terminal when the first value of the first configuration parameter is not included in the first UAI, wherein the first value and the second value of the first configuration parameters are different;
receiving a second OtherConfig element of a second RRC reconfiguration message comprising the second value of the first configuration parameter corresponding to the second UAI from the network terminal; and
applying the second value of the first configuration parameter when the second RRC reconfiguration message comprises the second value of the first configuration parameter before a timer expires.

5. The UAI negotiation method of claim 1, further comprising:
sending a second UAI including a second value of a second configuration parameter of the configuration parameters to the network terminal when the second configuration parameter is not included in the first UAI, wherein the second configuration parameter and the first configuration parameter are different;
receiving a second OtherConfig element of the second RRC reconfiguration message comprising the second value of the second configuration parameter corresponding to the second UAI from the network terminal; and
applying the second value of the second configuration parameter when the second RRC reconfiguration message comprises the second value of the second configuration parameter before a timer expires.

6. The UAI negotiation method of claim 1, further comprising:
receiving an RRC connect release message with an idle mode reselection priority assignment when the network terminal stops the UAI negotiation; or
receiving redirection information to another cell of same radio access technology (RAT) or another RAT when the network terminal stops the UAI negotiation.

7. The UAI negotiation method of claim 1, further comprising:
receiving an RRC connect release message and entering an inactive mode with suspend when the network terminal stops the UAI negotiation; or
resuming to a basic configuration when the network terminal stops the UAI negotiation.

8. The UAI negotiation method of claim 1, further comprising:
triggering an RRC connection re-establishment procedure to reset the UAI when the UE stops the UAI negotiation; or
reducing a power consumption of the UE when the UE stops the UAI negotiation.

9. The UAI negotiation method of claim 1, further comprising:
sending a secondary cell group (SCG) failure information when the UE stops the UAI negotiation; or
applying an uplink (UL) throttle when the UE stops the UAI negotiation.

10. A user equipment (UE) for mobile communication, comprising:
a wireless transceiver, configured to perform wireless transmission and reception to and from a network terminal of a mobile communication network; and
a controller, configured to receive a first OtherConfig element of an RRC reconfiguration message comprising a plurality of configuration parameters with SETUP values from a network terminal; send a first user equipment assistance information (UAI) including a first value of a first configuration parameter of the configuration parameters to the network terminal; and receive a first RRC reconfiguration message corresponding to the first UAI from the network terminal.

11. The UE of claim 10, wherein the controller is configured to determine whether the RRC reconfiguration message from the network terminal comprises the first value of the first configuration parameter; and apply the first value of the first configuration parameter when the first RRC reconfiguration message comprises the configuration parameter before a timer expires.

12. The UE of claim 10, wherein the controller of the UE is configured to determine whether the first configuration parameter of the RRC reconfiguration message is with a release value or not; and stop the timer.

13. The UE of claim 10, wherein the controller of the UE is configured to send a second UAI including a second value of the first configuration parameter to the network terminal when the first value of the first configuration parameter is not included in the first UAI, wherein the first value and the second value of the first configuration parameters are different; receive a second OtherConfig element of a second RRC reconfiguration message comprising the second value of the first configuration parameter corresponding to the second UAI from the network terminal; and apply the second value of the first configuration parameter when the second RRC reconfiguration message comprises the second value of the first configuration parameter before a timer expires.

14. The UE of claim 10, wherein the controller of the UE is configured to send a second UAI including a second value of a second configuration parameter of the configuration parameters to the network terminal when the second configuration parameter is not included in the first UAI, wherein the second configuration parameter and the first configuration parameter are different; receive a second OtherConfig element of the second RRC reconfiguration message comprising the second value of the second configuration parameter corresponding to the second UAI from the network terminal; and apply the second value of the second configuration parameter when the second RRC reconfiguration message comprises the second value of the second configuration parameter before a timer expires.

15. The UE of claim 10, wherein the controller of the UE is configured to receive an RRC connect release message with an idle mode reselection priority assignment when the network terminal stops the UAI negotiation; or receive redirection information to another cell of same radio access technology (RAT) or another RAT when the network terminal stops the UAI negotiation.

16. The UE of claim 10, wherein the controller of the UE is configured to receive an RRC connect release message and entering an inactive mode with suspend when the network terminal stops the UAI negotiation; or resume to a basic configuration when the network terminal stops the UAI negotiation.

17. The UE of claim 10, wherein the controller of the UE is configured to trigger an RRC connection re-establishment procedure to reset the UAI when the UE stops the UAI negotiation; or reduce a power consumption of the UE when the UE stops the UAI negotiation.

18. The UE of claim 10, wherein the controller of the UE is configured to send a secondary cell group (SCG) failure information when the UE stops the UAI negotiation; or apply an uplink (UL) throttle when the UE stops the UAI negotiation.

19. A network terminal station for mobile communication, comprising:
a core network; and
an access network, configured to transmit a first OtherConfig element of an RRC reconfiguration message comprising a plurality of configuration parameters with SETUP values to a user equipment (UE); receive a first user equipment assistance information (UAI) including a first value of a first configuration parameter of the configuration parameters from the UE; and send a first RRC reconfiguration message corresponding to the first UAI to the UE.

20. The network terminal of claim 19, wherein the access network is configured to receive a second UAI including a second value of the first configuration parameter from the UE, wherein the first value and the second value of the first configuration parameters are different; and send a second OtherConfig element of a second RRC reconfiguration message comprising the second value of the first configuration parameter corresponding to the second UAI to the UE.
